(19) United States
(12) Patent Application Publication
(10) Pub. No.: US 2006/0051519 A1
(43) Pub. Date: Mar. 9, 2006

(54) Multi-stage processes for drying and curing substrates coated with aqueous basecoat and a topcoat

(76) Inventors: Dennis M. Dixon, Flint, MI (US); Basil V. Gregorovich, Wilmington, DE (US); John R. Moore, Leonard, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/933,752

(22) Filed: Sep. 3, 2004

(51) Int. Cl. B05D 3/02

(52) U.S. Cl. 427/487

(57) ABSTRACT

A multi-stage process for drying and curing substrates coated with liquid waterborne basecoat and a topcoat includes: (a) applying a liquid waterbome basecoating composition to the substrate surface; (b) exposing the basecoating composition to air having a temperature ranging from ambient to about 40° C. for a period of about 30 seconds to volatilize at least a portion of volatile material from the liquid basecoating composition, the velocity of the air at the surface of the basecoating composition being about 0.3 to about 1 meter per second; (c) applying heated air to the basecoating composition for a period ranging from about 30 to about 45 seconds, the velocity of the air at the surface of the basecoating composition ranging from about 1.5 to 15 meters per second, the air having a temperature ranging from about 30° C. to about 90° C.; (d) applying infrared radiation and heated air simultaneously to the basecoating composition for a period of ranging from about 30 to 45 seconds, the velocity of the air at the surface of the basecoating ranging from about 1.5 to 5 meters per second, the air having a temperature ranging from about 30° C. to about 60° C., such that a sufficiently dried basecoat is formed upon the surface of the substrate; (e) applying a topcoating composition over the basecoat; and (f) simultaneously curing the basecoating composition and the topcoating composition together.

### CROSS-REFERENCE TO RELATED APPLICATION

This application claims priority under 35 U.S.C. § 119 from U.S. Provisional Application Ser. No. 60/499,651 (filed Sep. 3, 2003), which is incorporated by reference herein as if fully set forth.

### FIELD OF THE INVENTION

The present invention relates to drying of liquid waterborne coatings for automotive coating applications and, more particularly, to multi-stage processes for drying liquid waterbome coatings which include a combination of convection drying and infrared radiation for subsequent topcoat application, which is also referred to as the DuPont QwikDri™ Process.

### BACKGROUND OF THE INVENTION

Today's automobile bodies are treated with multiple layers of coatings which enhance the appearance of the automobile, for example, color, metallic effects, gloss etc., and also provide protection from, for example, corrosion, chipping, ultraviolet light, chemicals and other environmental conditions which can deteriorate the coating appearance and underlying car body.

The formulations of these coatings can vary widely. However, a major challenge that faces all automotive manufacturers is how to rapidly dry and cure these coatings with minimal capital investment and floor space, which is valued at a premium in manufacturing plants.

Various ideas have been proposed to speed up drying and curing processes for automobile coatings, such as hot air convection drying. While hot air drying is rapid, a skin can form on the surface of the coating which impedes the escape of volatiles from the coating composition and causes pops, bubbles or blisters which ruin the appearance of the dried coating.

Other methods and apparatus for drying and curing a coating applied to an automobile body are disclosed in U.S. Pat. Nos. 4,771,728; 4,907,533; 4,908,231 and 4,943,447.

Nowadays automotive manufacturers are also responding to environmental concerns with increased substitution of waterbased materials in place of solvent-based materials. This places an additional burden on the drying and curing process, since waterbased materials generally require longer drying times for the necessary water evaporation. Also, waterborne coatings are prone to certain defects described as pinholes during the drying and curing processes, due to air, water, and/or solvent entrapped in the coating caused by a mechanism similar to that described above. This places an additional burden on the automotive manufacturers, since these defects necessitate on-site repair of the vehicle's finish.

U.S. Pat. No. 6,291,027 discloses a method for accelerating the drying and curing of such waterbased systems using two back-to-back combined infrared radiation/heated air drying zones. Maintaining two infrared zones is not only expensive but also wasteful.

A rapid, economical, multi-stage drying process for automobile coatings is needed which inhibits formation of surface defects and strike-in in the coating, particularly for use with liquid waterborne basecoats to be overcoated with liquid topcoat.

### SUMMARY OF THE INVENTION

The present invention provides a process for coating a substrate and rapidly drying the coated substrate using just one infrared drying zone, in combination with simultaneous convection drying, particularly for use with liquid waterborne coatings, including primers, primer surfacers, basecoats and clearcoats.

The present invention is particularly directed to a process for rapidly drying liquid waterbome basecoats on a substrate for subsequent topcoat application, which comprises the steps of: (a) applying, typically in a spray booth, a liquid waterborne basecoating composition to a surface of the substrate; (b) exposing the basecoating composition, preferably in a flash zone, to air having a temperature ranging from about 20° C. (ambient) to about 40° C. for a period of at least about 30 seconds to volatilize at least a portion of volatile material from the liquid basecoating composition, the velocity of the air at a surface of the basecoating composition being about 0.3 to about 1 meters per second; (c) applying heated air to the basecoating composition, preferably in a convection oven zone, for a period of about 30 seconds to 2 minutes, the velocity of the air at the surface of the basecoating composition being about 1.5 to about 15 meters per second, the air having a temperature ranging from about 30° C. to about 90° C.; (d) applying continuous or pulsed infrared radiation, preferably at a power density of about 25 kW per square meter or less, and heated air simultaneously to the basecoating composition, preferably in a combined convection/infrared radiation oven zone, for a period from about 30 seconds to 2 minutes, the velocity of the air at the surface of the basecoating composition being about 1.5 to 5 meters per second, the air having temperature of from about 30° C. to about 60° C., such that a sufficiently dried basecoat is formed upon the surface of the substrate; and (e) applying a topcoating composition over the basecoat.

### BRIEF DESCRIPTION OF THE DRAWINGS

The foregoing summary, as well as the following detailed description of the preferred embodiments, will be better understood when read in conjunction with the appended drawings. In the drawings:

FIG. 1 is a flow diagram of a process for drying liquid basecoat for liquid topcoating according to the present invention;

FIG. 2 is a side elevational schematic diagram of a portion of the quick drying process of FIG. 1 performed on a continuous assembly line process;

FIG. 3 is a front elevational view taken along line 3-3 of a portion of the schematic diagram of FIG. 2; and

FIG. 4 is a front elevational view taken along line 4-4 of a portion of the schematic diagram of FIG. 2.

### DETAILED DESCRIPTION OF THE INVENTION

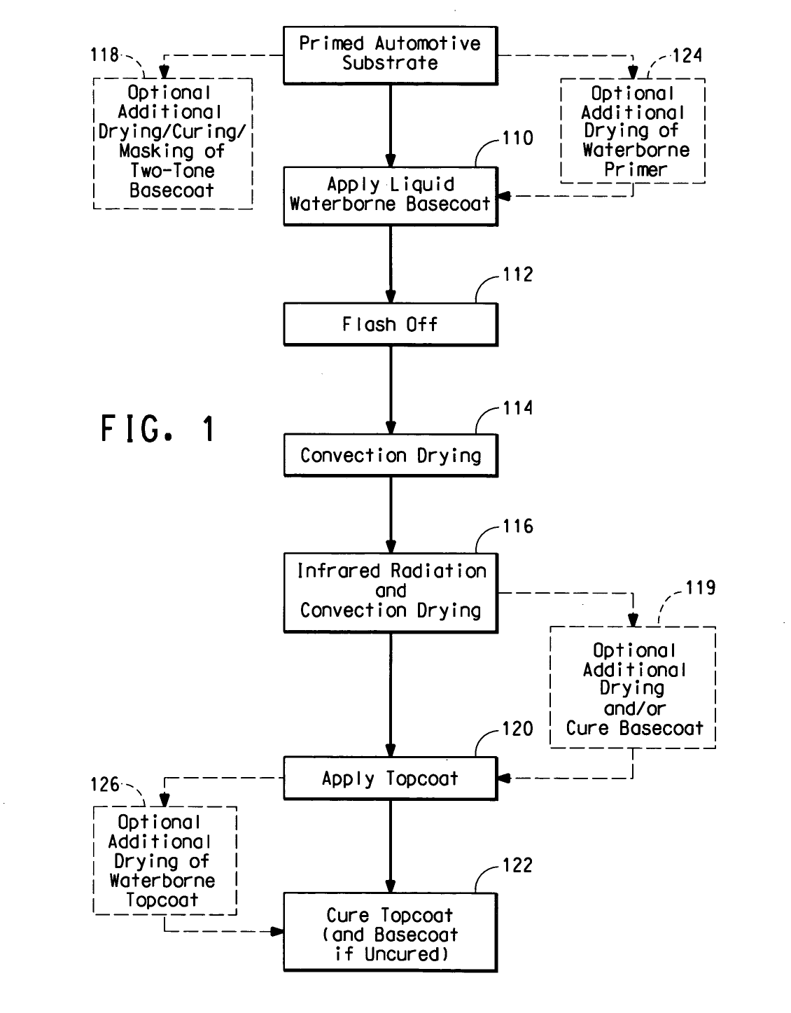

Referring to the drawings, in which like numerals indicate like elements throughout, there is shown in FIG. 1 a flow diagram of a multi-stage process for coating and drying a substrate according to the present invention.

The process of the present invention is suitable for drying any liquid waterbome coating, particularly automotive coatings, such as primers, primer-surfacers, basecoats, and clearcoats. The present invention will now be discussed generally in the context of drying liquid waterbome basecoats for subsequent topcoat application. One skilled in the art would understand that the process of the present invention, once properly located, also is useful for drying substrates coated with liquid waterbome primers, primer-surfacers, and/or topcoats.

This process is also suitable for coating metal or polymeric substrates in a batch or continuous process. In a batch process, the substrate is stationary during each treatment step of the process, whereas in a continuous process the substrate is in continuous movement along an assembly line. The present invention will now be discussed generally in the context of coating a substrate in a continuous assembly line process, although the process also is useful for coating substrates in a batch process.

Useful substrates that can be coated according to the process of the present invention include metal substrates, polymeric substrates, such as thermoset materials and thermoplastic materials, and combinations thereof. Useful metal substrates that can be coated according to the process of the present invention include ferrous metals such as iron, steel, and alloys thereof, non-ferrous metals such as aluminum, zinc, magnesium and alloys thereof, and combinations thereof. Preferably, the substrate is formed from cold rolled steel, electrogalvanized steel such as hot dip electrogalvanized steel or electrogalvanized iron-zinc steel, aluminum or magnesium.

Useful thermoset materials include polyesters, epoxides, phenolics, polyurethanes such as reaction injected molding urethane (RIM) thermoset materials and mixtures thereof. Useful thermoplastic materials include thermoplastic polyolefins such as polyethylene and polypropylene, polyamides such as nylon, thermoplastic polyurethanes, thermoplastic polyesters, acrylic polymers, vinyl polymers, polycarbonates, acrylonitrilebutadiene-styrene (ABS) copolymers, EPDM rubber, copolymers and mixtures thereof.

Preferably, the substrates are used as components to fabricate automotive vehicles, including but not limited to automobiles, trucks and tractors. The substrates can have any shape, but are preferably in the form of automotive body components such as bodies (frames), hoods, doors, fenders, bumpers and/or trim for automotive vehicles.

The present invention first will be discussed generally in the context of coating a metallic automobile body. One skilled in the art would understand that the process of the present invention also is useful for coating non-automotive metal and/or polymeric components.

Referring now to FIG. 1, as indicated above, the entire process is described in the context of drying substrates coated with a liquid waterbome basecoat for subsequent topcoat application.

Prior to treatment according to the process of the present invention, the metal substrate can be cleaned and degreased and a pretreatment coating, such as BONDERITE® 958 pretreatment, supplied by Henkel Technologies, Madison Heights, Mich., can be deposited upon the surface of the metal substrate. Alternatively or additionally, an electrodepositable coating composition can be electrodeposited upon the metal substrate. Useful electrodeposition methods and electrodepositable coating compositions include conventional anionic or cationic electrodepositable coating compositions, such as cationic epoxy based coatings discussed in U.S. Pat. Nos. 4,980,398; 5,095,051 and 5,356,960, which are incorporated herein by reference. Following the application of the pretreatment coating and electrodepositable coating, a suitable primer or primer surfacer, liquid or powder, may be applied.

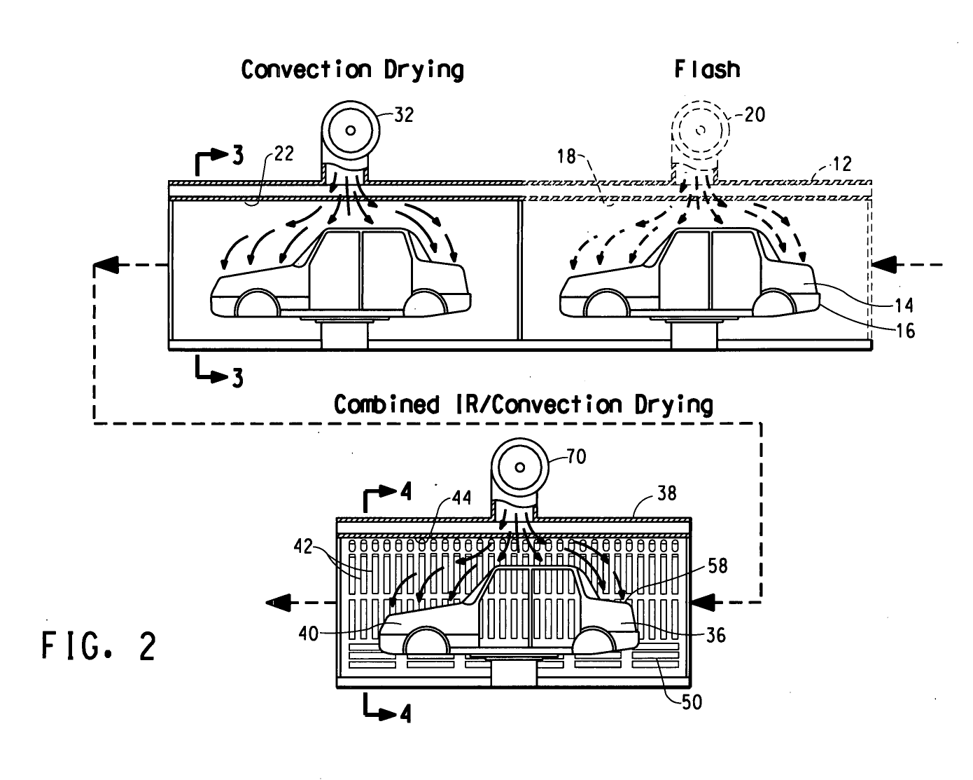

As shown in FIG. 1, after the pretreatment described above, a preferred liquid waterbome basecoating composition designed for our quick dry process is applied to a surface of the metal substrate (automobile body 16 shown in FIG. 2) in a first step 110, preferably over an electrodeposited coating as described above or primer. The liquid basecoating can be applied to the surface of the substrate in step 110 by any suitable coating process well known to those skilled in the art, for example by dip coating, direct roll coating, reverse roll coating, curtain coating, spray coating, brush coating and combinations thereof. The method and apparatus for applying the liquid basecoating composition to the substrate is determined in part by the configuration and type of substrate material.

In automotive assembly plants, however, it is generally preferred that spray application in spray booths be used since the best results are achieved in terms of pigment control, especially of flake pigment orientation. Any of the known spray procedures may be adopted, such as compressed air spraying, electrostatic spraying (gun or rotary bell), hot spraying and airless spraying, and either manual or automatic methods are suitable. Most commonly, the basecoat is applied in two coats, one coat with conventional electrostatic spray equipment such as a high speed (about 20,000 to about 100,000 revolutions per minute) rotary bell atomizer at a high voltage (about 60,000 to about 90,000 volts) and a second coat with conventional air atomized spray equipment.

The preferred liquid basecoating composition used in this invention is a pigmented composition which comprises a film-forming material or binder, optionally crosslinking agents, volatile liquid material and pigment particles dispersed in the liquid for appropriate color, effect and hiding. The volatile material employed in the basecoating of the present invention is an aqueous liquid medium, which makes drying the basecoating much more difficult. This is commonly referred to as an aqueous or waterbome basecoating composition which is increasingly being used in automotive assembly plants to reduce solvent emissions. By “aqueous liquid medium,” it is meant either water alone or water mixed with one or more coalescing solvents such as alcohols, ketones, esters, glycol ethers and the like. The aqueous medium may also and preferably does contain water-soluble substances introduced for the purpose of adjusting the pH of the basecoat composition, as will be appreciated by those skilled in the art.

Any of a wide variety of commercially available automotive waterbome basecoating compositions may be employed in the present invention, such as any of those used nowadays at automotive assembly plants. Typically, these compositions are either self-drying (physically drying), self-crosslinking, or extraneously crosslinking (thermosetting) compositions, based on one or more film-forming materials or binders and optionally crosslinking agents, volatile liquid material, pigments and/or fillers, and other paint industry additives. One such coating based on core-shell latex technology is disclosed in U.S. Pat. No. 5,219,900 incorporated herein by reference.

Preferably, the basecoating is a crosslinkable coating composition comprising at least one water-compatible thermosettable film-forming material, such as acrylics, polyesters (including alkyds), polyurethanes and epoxies, at least one water-dispersible crosslinked polymer microparticle or microgel, such as acrylic microgel particles or latices, and at least one crosslinking material, such as aminoplasts, polyisocyanates, polyacids, polyanhydrides and mixtures thereof. Self-crosslinkable and thermoplastic film-forming materials can also be used. The amount of film-forming material in the liquid basecoat generally ranges from about 40-98 weight percent on a basis of total weight solids of the basecoating composition. The solids content of the liquid basecoating composition generally ranges from about 10-60 weight percent, and preferably about 20-50 weight percent.

The basecoating composition can further comprise one or more pigments or other additives such as catalysts, UV absorbers, rheology control agents and surfactants. Useful flake pigments include aluminum flake, bronze flakes, coated mica, nickel flakes, tin flakes, silver flakes, copper flakes and combinations thereof. Other suitable pigments include iron oxides, carbon black, titanium dioxide and colored organic pigments such as phthalocyanines. The specific pigment to binder ratio can vary widely so long as it provides the requisite hiding and effect (such as “solid color”, “glamour metallic” or “pearlescent” effect) at the desired film thickness and application solids.

Suitable crosslinkable thermosetting waterbome basecoats (also known as enamels) for color-plus-clear (also known as basecoat/clearcoat) composite coatings include those disclosed in U.S. Pat. Nos. 4,403,003; 4,539,263; 5,198,490; 5,401,790 and 5,071,904, which are incorporated by reference herein. Suitable non-crosslinkable, self-drying waterbome basecoats (also known as lacquers) for color-plus-clear composite coatings include those disclosed in U.S. Pat. Nos. 5,760,123 and 6,069,218, which are incorporated by reference herein. Suitable self-crosslinkable waterbome basecoat enamels for color-plus-clear composite coatings include those described in U.S. Pat. No. 5,681,622, which is incorporated by reference herein.

The thickness of the basecoating composition applied to the substrate can vary based upon such factors as pigmentation, the type of substrate and intended use of the substrate, i.e., the environment in which the substrate is to be placed and the nature of the contacting materials. Generally, the thickness of the basecoating composition applied to the substrate ranges from about 0.4-1.5 mils (about 10-40micrometers), and more preferably about 0.5-1.2 mils (about 12-30 micrometers).

Referring now to FIGS. 1 and 2, after applying the basecoat, the process of the present invention includes a second step 12, 112 of exposing the basecoating composition to low velocity air or dehydrated air having a temperature ranging from about 20° C. (ambient) to about 40° C., and preferably about 20° C. to about 30° C., for a period of at least about 15 seconds, preferably at least about 30 seconds to volatilize at least a portion of the volatile material from the liquid basecoating composition and “coalesce” the basecoat so that a film is formed. This initial forced drying step is commonly referred to as a “flash off” or “flash drying” step, which preferably takes place in what is known as the “flash zone” which is located after the spray booth in the continuous assembly line process. Preferably, there is a quiet zone (not shown) positioned between the spray booth and flash zone, wherein the basecoat is exposed to virtually no air movement for a maximum of about 15-30 seconds before the flash drying step is performed.

Once in the flash drying zone 12, 112, the velocity of the air at a surface of the basecoating composition during this step preferably ranges from about 0.3 to about 1 meters per second, so as to not disturb or mar (wave or ripple) the film by air currents which blow past the basecoated surface.

The volatilization or evaporation of volatiles from the basecoat 14 during this step can be carried out in the open air, but is preferably carried out in a flash off chamber 18 in which dehydrated or heated air is circulated at low velocity, as shown in FIG. 2, to minimize airborne particle contamination and also to minimize the unfavorable effects of humid ambient air, as shown in FIG. 2. The automobile body 16 is positioned at the entrance to the flash off chamber 18 and moved therethrough in assembly-line manner at a rate which permits the volatilization of the basecoat as discussed above. No infrared heaters are used in this step. The rate at which the automobile body 16 is moved through the first drying chamber 18 and the other drying chambers discussed below depends in part upon the length and configuration of the drying chamber 18, but preferably ranges from about 3 meters per minute to about 9 meters per minute for a continuous process. One skilled in the art would understand that individual dryers can be used for each step of the process or that a single dryer having a plurality of individual drying chambers or sections (shown in FIG. 2) configured to correspond to each step of the process can be used, as desired.

The air preferably is supplied to the flash off chamber 18 by an optional blower 20 or dryer, shown in phantom in FIG. 2. The air can be circulated at ambient temperature or heated, if necessary, to the desired temperature range of about 20° C. to about 40° C. Preferably, the basecoating composition is exposed to air for a period ranging from about 30 seconds to about 2 minutes before the automobile body 16 is moved to the next stage of the drying process.

Referring once more to FIGS. 1 and 2, the process comprises a next step 114 of applying relatively high velocity heated air (convection drying) to the basecoating composition for a period of at least about 15 seconds, preferably at least about 30 seconds, and more preferably about 45 seconds up to about 2 minutes, in order to remove a major portion of the volatile liquid material from the basecoating. This step is commonly referred to as a “convection drying” step, which preferably takes place in a “convection oven zone” that comes after the flash zone.

This convection drying of volatiles from the basecoat 14 is preferably carried out in a convection drying chamber 22 in which heated air (i.e., warm to hot air) is circulated at high velocity over the surface of the vehicle to continue to dehydrate the coating film. During this stage, it is desirable to form either a slightly tacky or preferably a tack-free (resists adherence of dust and other airborne contaminants) film upon the surface of the vehicle.

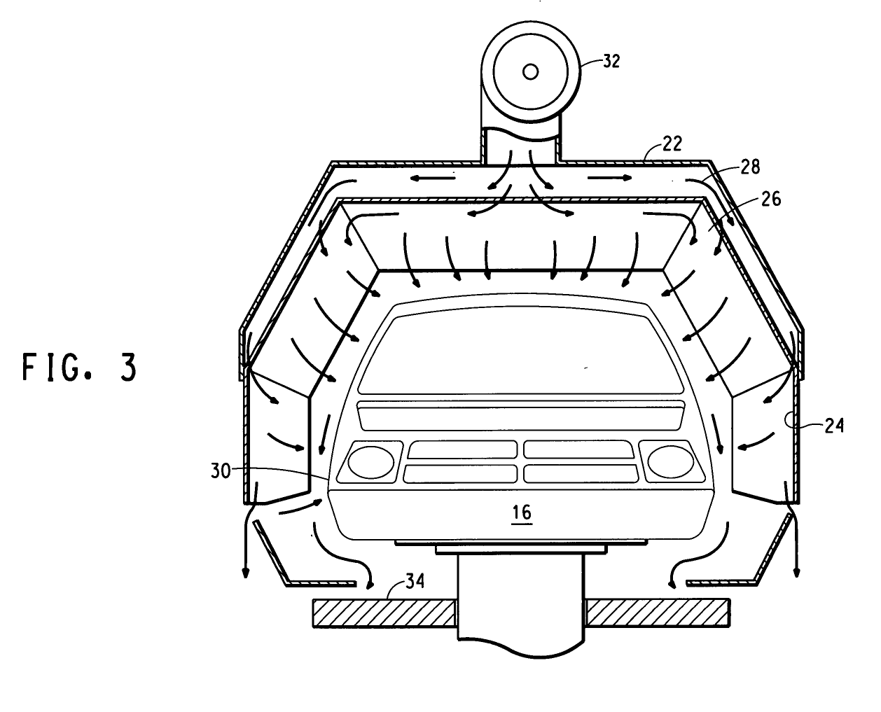

Referring now to FIGS. 2 and 3, the preferred convection drying apparatus 22 includes baffled side walls 24 having nozzles or slot openings 26 through which air 28 is passed to enter the interior drying chamber 22. During this step, the velocity of the air at the surface 30 of the basecoating composition ranges from about 1.5 meters per second to about 15 meters per second, preferably from about 2.0 to about 10.0 meters per second and, more preferably, from about 3.0 to about 7.0 meters per second.

The temperature of the air 28 in the convection zone generally ranges from about 30° C. to about 90° C., and preferably about 40° C. to about 80° C. Whatever the case may be, the air should be kept below 90° C. to prevent the water remaining in the coating from boiling and damaging the film. The air is supplied by a blower 32 or dryer and can be preheated externally or by passing the air over heating elements (not shown) mounted in the chamber. Also, undesirable solvent vapors can be removed from the interior of the convection drying chamber 22 through ducts formed in the external walls or can be circulated up through the interior drying chamber 22 via the subfloor 34. Preferably, the air flow is recirculated to increase efficiency. A portion of the air flow can be bled off to remove contaminants and filtered fresh air can be added to make up for any losses.

The automobile body 16 is positioned at the entrance to the convection drying chamber 22 and slowly moved therethrough in assembly-line manner at a rate which permits the volatilization of water in the basecoat as discussed above. No infrared heaters are used in this step. If infrared heaters are installed in this convection drying chamber (not shown in FIG. 3), they should be turned off.

Referring again to FIGS. 1 and 2, the process of the present invention comprises another drying step 116, also referred to herein as a “combination convection/IR drying” step, which preferably takes place in a combination “convention/IR oven zone” that follows the convention oven zone described above. This step constitutes the last drying step before an overcoat can be applied to the basecoat. Convection continually removes the water as it is evaporated and sufficient temperature continues the evaporation at the desired rate. However, as solids of the basecoat on the substrate increase water becomes increasingly difficult to remove because it is removed by a slower diffusion process requiring higher energy input. This is where radiant energy is most useful and cost effective, since it penetrates into the coating and directly activates the water molecules thus vaporizing the water very effectively. This provides an internal driving force for removal of water in the latter stages of drying that is much more effective than convection drying at the surface alone. However, convection drying is still needed at this stage to remove water from the surface. In contrast to the teachings of U.S. Pat. No. 6,291,027, which was mentioned previously, in the present invention infrared radiation is only used during this final drying step 116 of the basecoat drying process, as opposed to in both the second to last and last steps.

In an alternate embodiment, another possible arrangement of drying chambers which can be used in the present invention places the IR/convection zone 116 ahead of the convection zone 114. Although this arrangement is less desirable than using IR in the final drying zone, there may be individual automotive assembly line circumstances where this arrangement is adequate and would still save the expense, maintenance and complication associated with two IR zones.

Again referring to the preferred embodiment shown in FIGS. 1 and 2, the last drying step 116 before topcoat application employed in the present invention thereby comprises applying both infrared radiation and heated (i.e., warm) air simultaneously to the basecoating composition on the metal substrate (automobile body 16) for a period of at least about 15 seconds, preferably at least about 30 seconds, and more preferably about 45 seconds up to about 2 minutes. The velocity of the air at the surface of the basecoating composition in this drying step is generally less than about 5 meters per second, and preferably ranges from about 1.5 to about 5 meters per second. The warm drying air generally has a temperature ranging from about 30° C. to about 60° C. The solids of the applied coating, at this point in the process, should be at least 70% to 100%, preferably 80% to 95%, more preferably 85% to 95%, thus forming a dried basecoat upon the surface of the substrate. By “dried” it is meant that the basecoat is dried sufficiently such that the quality of the topcoat (or semi-transparent pearlcoat in the case of a tricoat finish) applied thereover will not be affected adversely.

This combination IR/convection drying step can be carried out in a combined infrared radiation/convection drying chamber 38. The automobile body 16 is positioned at the entrance to this combination drying chamber 38 and slowly moved therethrough in assembly-line manner at a rate which permits the volatilization of the basecoat as discussed above.

Generally, any conventional combination infrared/convection drying apparatus can be used in step 116 such as the combined infrared radiation and heated air convection ovens which are described below. The individual infrared emitters can be configured as discussed below and controlled individually or in groups by a microprocessor (not shown) to provide the desired heating and infrared energy transmission rates.

The radiant energy applied is within the radiation spectrum from about 0.7 to 100,000 μM. This range includes the infrared region of wavelengths from about 0.7 to 100 μM. Preferably the radiation range includes the near-infrared region (0.7 to 1.5 micrometers) and the intermediate-infrared region (1.5 to 20 micrometers) radiation, and more preferably the wavelength range from about 0.7 to about 4 micrometers. The radiation can also include microwave radiation with wavelengths from about 100 to 100,000 μM, and more preferably the FCC Frequency designation for Manufacturers from 462.200 to 462.500 MHz. The radiation that is applied heats the Class A (external) surfaces 40 of the coated substrate which are exposed to the radiation. Most non-Class A surfaces are not exposed directly to radiation but will be heated through conduction through the automobile body and random scattering of the radiation. The use of microwaves requires specific safety requirements well known to those skilled in the art and so further discussion will describe only the infrared usage.

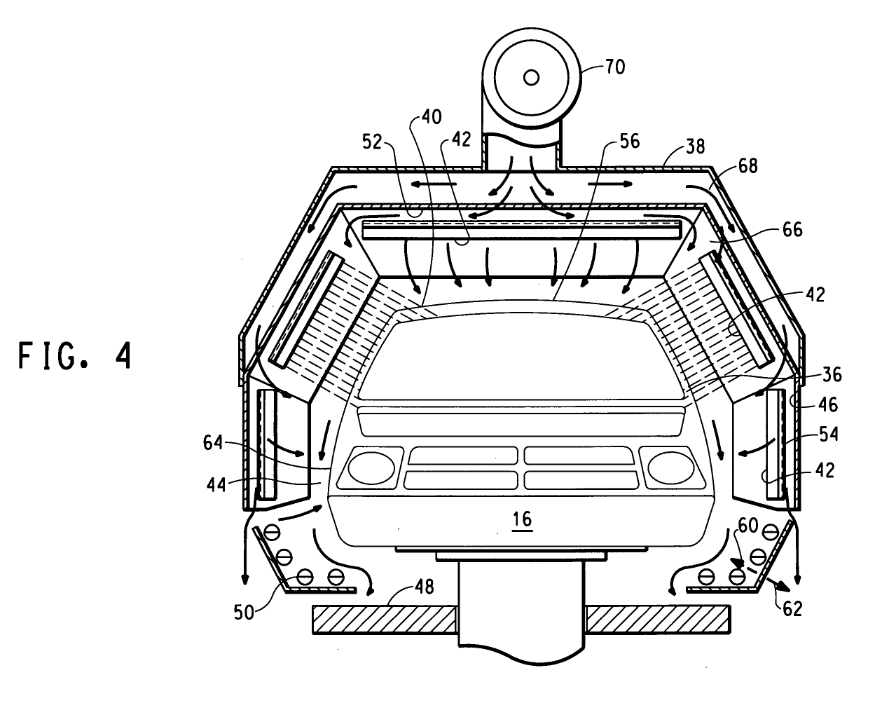

Referring now to FIGS. 2 and 4, the infrared radiation is emitted by a plurality of emitters 42 arranged in the interior drying chamber 44 of the combination infrared/convection drying apparatus 38. Each emitter 42 is preferably a high intensity infrared lamp, preferably a quartz envelope lamp having a tungsten filament. Useful short wavelength (0.76 to 2 micrometers), high intensity lamps include Model No. T-3 lamps such as are commercially available from General Electric Co., Sylvania, Phillips, Heraeus and Ushio and have an emission rate of between 75 and 100 watts per lineal inch at the light source. While short wavelength lamps can be used at less than 100% power to avoid problems associated with these bulbs, it is generally desired to use medium wavelength (2 to 4 micrometers) lamps, at least first, to prevent the surface from being sealed too quickly which impedes the escape of volatiles from the coating composition and causes pops, pinholes, bubbles or blisters which ruin the appearance of the dried coating. The preferred medium wave IR lamps are available from the same suppliers. The emitter lamp 42 is preferably generally rod-shaped and has a length that can be varied to suit the configuration of the oven, but generally is preferably about 0.75 to about 1.5 meters long. Preferably, the emitter lamps on the side walls 46 of the interior drying chamber 44 are arranged generally vertically with reference to ground 48, except for a few rows 50 (preferably about 3 to about 5 rows) of emitters at the bottom of the interior drying chamber 44 which are arranged generally horizontally to ground 48.

The number of emitters 42 can vary depending upon the desired intensity of energy to be emitted. In a preferred embodiment, the number of emitters 42 mounted to the ceiling 52 of the interior drying chamber 44 is about 24 to about 32 arranged in a linear side-by side array with the emitters spaced about 10 to about 20 centimeters apart from center to center, and preferably about 15 centimeters. The width of the interior drying chamber 44 is sufficient to accommodate the automobile body or whatever substrate component is to be dried therein, and preferably is about 2.5 to about 3.0 meters wide. Preferably, each side wall 46 of the chamber 44 has about 50 to about 60 lamps with the lamps spaced about 15 to about 20 centimeters apart from center to center.

The length of each side wall 46 is sufficient to encompass the length of the automobile body and body carrier or whatever substrate component is being dried therein, and preferably is about 7 to about 8 meters. The side wall 46 preferably has four horizontal sections that are angled to conform to the shape of the sides of the automobile body. The top section of the side wall 46 preferably has 24 parallel lamps divided into 6 zones. The three zones nearest the entrance to the drying chamber 44 are operated at medium wavelengths, the three nearest the exit at short wavelengths. The middle section of the side wall is configured similarly to the top section. The two lower sections of the side walls each preferably contain 6 bulbs in a 2 by 3 array. The first section of bulbs nearest the entrance is preferably operated at medium wavelength and the other two sections at short wavelengths.

Referring again to FIG. 4, each of the emitter lamps 42 is disposed within a trough-shaped reflector 54 that is preferably formed from polished aluminum. Suitable reflectors include aluminum or integral gold-sheathed reflectors that are commercially available from BGK-ITW Automotive, Heraeus and Fannon Products. The reflectors 54 gather energy transmitted from the emitter lamps and focus the energy on the automobile body 16 to lessen energy scattering.

Depending upon such factors as the configuration and positioning of the automobile body 16 within the interior drying chamber 44 and the color of the basecoat to be dried, the emitter lamps 42 can be independently controlled by microprocessor (not shown) such that the emitter lamps furthest from a Class A surface 40 can be illuminated at a greater intensity than lamps closest to a Class A surface to provide uniform heating. For example, as the roof 56 of the automobile body 16 passes beneath a section of emitter lamps, the emitter lamps in that zone can be adjusted to a lower intensity until the roof has passed to prevent the roof from buckling under the heat, then the intensity can be increased to heat the deck lid 58 which is at a greater distance from the emitter lamps 42 than the roof 56.

Also, in order to minimize the distance from the emitter lamps 42 to the Class A surfaces 40, the position of the side walls 46 and emitter lamps 42 can be adjusted toward or away from the automobile body as indicated by directional arrows 60, 62, respectively, in FIG. 4. One skilled in the art would understand that the closer the emitter lamps are to the Class A surfaces of the automobile body 16, the greater the percentage of available energy which is applied to heat the surfaces and coatings present thereon. Generally, the infrared radiation is emitted at a power density ranging from about 10 to about 25 kilowatts per square meter (kW/m²) of emitter wall surface, and preferably about 12 kW/m² for emitter lamps 42 facing the sides 64 of the automobile body 16 (doors or fenders) which are closer than the emitter lamps 42 facing the hood and deck lid 58 of the automobile body 16, which preferably emit about 24 kW/m².

The emitter lamps 42 can also be pulsed to prevent the automobile body from overheating and buckling under the high intensity heat. The pulse frequency can also be independently controlled by the microprocessor (not shown).

Non-limiting examples of suitable combination infrared/convection drying apparatus are those commercially available from Durr of Wixom, Mich., Thermal Innovations of Manasquan, N.J., Thermovation Engineering of Cleveland, Ohio, Dry-Quick of Greenburg, Ind. and Wisconsin Oven and Infrared Systems of East Troy, Wis. Another useful IR/convention drying ovens, which has been used in the past in automotive assembly plants, is a BGK combined infrared radiation and heated air convection oven, which is commercially available from BGK Automotive Group of Minneapolis, Minn. The general configuration of this oven will be described below and is disclosed in U.S. Pat. Nos. 4,771,728; 4,907,533; 4,908,231; and 4,943,447, which are hereby incorporated by reference. Other useful combination infrared/convection drying apparatus will be apparent to those skilled in the art.

Referring now to FIG. 4, the preferred combination infrared/convection drying apparatus 38 is shown. In some cases, this apparatus might be the same type of apparatus used in the previous drying step except that in the previous drying step, the infrared emitters will be turned off. Like the previous convection drying chamber, the preferred combination infrared/convection drying apparatus 38 includes baffled side walls 46 having nozzles or slot openings 66 through which air 68 is passed to enter the interior of the drying chamber 38 at a velocity of no less than about 5 meters per second. During this step, the velocity of the air at the surface 36 of the basecoating composition is less than about 5 meters per second, preferably ranges from about 1.5 to about 5 meters per second and, more preferably, about 2 to about 4 meters per second.

The temperature of the air 68 generally ranges from about 30° C. to about 60° C., and preferably about 30° C. to about 40° C. The low velocity warm drying air 68 is supplied by a blower 70 or dryer and can be preheated externally or by passing the air over the heated infrared emitter lamps 42 and their reflectors 54. By passing the air 68 over the emitters 42 and reflectors 54, the working temperature of these parts can be decreased, thereby extending their useful life. Also, undesirable solvent vapors can be removed from the interior drying chamber. The air can also be circulated up through the interior of the combination drying chamber via the subfloor 48. Preferably, the air flow is recirculated to increase efficiency. A portion of the air flow can be bled off to remove contaminants and supplemented with filtered fresh air to make up for any losses.

As would be understood by one skilled in the art, by controlling the rate at which the substrate temperature is increased and the peak substrate temperature, the combination of steps 112, 114 and 116 can provide liquid basecoat and liquid or powder topcoat composite coatings with a minimum of flaws in surface appearance, such as pops, pinholes and bubbles. High film builds can also be achieved in a short period of time with minimum energy input and the flexible operating conditions can decrease the need for on-site repairs.

The basecoat 36 that is formed upon the surface of the automobile body 16 during combined infrared/convention drying step 116 is dried sufficiently to enable application of the topcoat such that the quality of the topcoat (or intermediate coat in some cases) or appearance of the basecoat will not be affected adversely.

If too much water is present, the topcoat applied thereover can exhibit cracks, bubbles, pops, or pinholing during drying of the topcoat as water vapor from the basecoat attempts to pass through the topcoat. Too much water can also cause the topcoat to strike-in to the basecoat and create a film with poor appearance, that is, basecoat mottle, poor gloss and DOI (distinctness of image).

The process of the present invention may comprise an optional drying and/or curing step 118, shown in phantom in FIG. 1. An additional drying chamber 118 is especially useful with automotive wet-on-wet processes that employ additional coatings for added color effects, e.g., the lower two tone finishes. For instance, it may be desirable to spray a solvent or waterborne lower two-tone coat for an additional color effect before the topcoat is applied. Thereafter the automobile can be sent to the additional drying chamber 118 for sufficient drying and masking prior to upper basecoat color application and passage through steps 110 through 116. In an alternate embodiment, the vehicle can be sent back through the spray and quick drying process zones 110, 112, 114 and 116 a second time (not shown) to rapidly dry the two-tone finish before the topcoat is applied. Apart from two-tone finishes, it might also be desirable to have an individual basecoat curing step 119 for certain thermosetting compositions, in which hot air is applied to the dried basecoat 36 typically for a period of at least about 6 minutes, preferably about 6 to 20 minutes after step 116 to hold the coated substrate at a peak metal temperature ranging from about 110° C. to 135° C. and cure the basecoat. As used herein, “cure” means that any crosslinkable components of the dried basecoat are substantially crosslinked.

These additional drying and/or curing steps 118 and 119 can be carried out using a hot air convection dryer, such as are discussed above or in a similar manner to that of step 116 above using a combination infrared radiation/convection drying apparatus.

The process of the present invention can further comprise a cooling step (not shown) in which the temperature of the automobile body 16 having a cured basecoat thereon from steps 116 and/or 119, typically at about 50-60° C., is cooled. However, one skilled in the art would appreciate that this step is not typically needed for automotive facilities, since clear topcoats used nowadays are designed to go on hot bodies.

After the basecoating on the automobile body 16 has been dried (and cured and/or cooled, if desired), topcoating composition is applied over the dried basecoat in a topcoating step 120.

Any of a wide variety of commercially available automotive clearcoats may be employed in the present invention, including standard solvent borne, waterborne or powder clears, slurry powder clears, UV clears, 2K clears and the like.

The clear topcoat can be applied by conventional electrostatic spray equipment such as a high speed (about 20,000 to about 100,000 revolutions per minute) rotary bell atomizer at a high voltage (about 60,000 to about 90,000 volts) to a thickness of about 40 to about 65 micrometers in one or two passes.

Preferably, the clear topcoating composition is a crosslinkable coating comprising at least one thermosettable film-forming material and at least one crosslinking material, although thermoplastic film-forming materials such as polyolefins can be used. High solids solvent borne clearcoats which have low VOC (volatile organic content) and meet current pollution regulations are generally preferred. Typically useful high solids solvent borne topcoats include those based on high solids carbamate/melamine or acrylosilane/melamine resins, which are disclosed in U.S. Pat. Nos. 6,607,833; 5,162,426; and 4,591,533, which are incorporated by reference herein, 2K clearcoats based on polyisocyanate disclosed in U.S. Pat. No. 6,544,593, which is incorporated by reference herein and SuperSolids™, very high solids coatings, based on oligomeric silanes disclosed in U.S. Pat. No. 6,080,816 which is incorporated by reference herein.

The clear topcoating composition can also include other crosslinking materials and additional ingredients such as are discussed above. The compositions may be pigmentless or may contain small amounts of pigment provided the resulting clearcoat is still substantially transparent. The amount of the topcoating composition applied to the substrate can vary based upon such factors as the type of substrate and intended use of the substrate, i.e., the environment in which the substrate is to be placed and the nature of the contacting materials. A liquid solventborne top coating is generally preferred over waterborne basecoat to give an attractive automotive appearance with excellent gloss and DOI (distinctness of image).

In a preferred embodiment, the process of the present invention further includes a curing step 122, also referred to as a baking step, (shown in FIG. 1), to cure the liquid topcoating composition after application over the dried basecoat. The thickness of the dried and crosslinked clearcoat is generally about 1 to about 5 mils (about 25 to 125 micrometers), and preferably about 1.5 to about 3 mils (about 37 to 75 micrometers). The liquid topcoating can be cured by hot air convection drying and, if desired, infrared heating, such that any crosslinkable components of the liquid topcoating are crosslinked to such a degree that the automobile industry accepts the coating process as sufficiently complete to transport the coated automobile body without damage to the topcoat. The liquid topcoating can be cured using any conventional hot air convection dryer or combination convection/infrared dryer such as are discussed above. Generally, the liquid topcoating is heated to a temperature of about 120° C. to about 150° C. for a period of about 20 to about 40 minutes to cure the liquid topcoat.

Alternatively, if the basecoat was not cured prior to applying the liquid topcoat (which is commonly referred to as “wet-on-wet” application, i.e., the topcoat is applied to the basecoat without curing or completely drying the basecoat), both the basecoat and the liquid topcoating composition can be cured together by applying hot air convection and/or infrared heating using apparatus such as are described in detail above to individually cure both the basecoat and the liquid coating composition. To cure the basecoat and the liquid coating composition, the substrate is generally heated to a temperature of about 120° C. to about 150° C. for a period of about 20 to about 40 minutes to cure both the liquid basecoat and topcoat. Wet-on-wet application of the topcoat to the basecoat is generally preferred nowadays in automotive assembly plants, since it minimizes the floor space needed to run the painting operation, which is valued at a premium in assembly plants. To enable wet-on-wet application, steps 114 and 116 are managed such that the film is not heated to a temperature sufficient to induce complete drying or chemical reaction or significant crosslinking of the components of the basecoating before application of the topcoat.

Another aspect of the present invention is a process for coating an automotive polymeric substrate. The process includes steps similar to those used for coating a metal substrate above, with the exception that the process is not run above the deformation or distortion temperature of the substrate. The heat distortion temperature is the temperature at which the polymeric substrate physically deforms and is incapable of resuming its prior shape. For example, the heat distortion temperatures for several common thermoplastic materials are as follows: thermoplastic olefins about 138° C. (280° F.), thermoplastic polyurethanes about 149° C. (300° F.), and acrylonitrile-butadiene-styrene copolymers about 71-82° C. (160-180° F.).

As would be understood by one skilled in the art, the process of the present invention can also be used to rapidly dry liquid waterborne primers, primer-surfacers and topcoats (i.e., clearcoats) coated on a surface of a substrate. The blocks 124 and 126 shown in phantom in FIG. 1 indicate that drying and optional curing steps 112, 114, 116 and 118 can also be used with respective waterbome primers and waterbome topcoats.

It will be appreciated by one skilled in the art that changes made from the embodiments heretofore described would not result in a departure from the inventive concept. It is therefore understood that this invention is not limited to the particular embodiments disclosed, but is intended to cover modifications that are within the spirit and scope of the invention as defined by the appended claims.

We claim:

1. A process for drying substrates coated with liquid waterborne basecoats, comprising the steps of: (a) applying a waterborne basecoating composition to a surface of the substrate; (b) exposing the basecoating composition to air having a temperature ranging from about 20° C. to about 40° C. for a period of about 30 seconds to volatilize at least a portion of volatile material from the liquid basecoating composition, the velocity of the air at a surface of the basecoating composition being about 0.3 to about 1 meter per second; (c) applying heated air to the basecoating composition for a period of about 30 seconds to 2 minutes, the velocity of the air at the surface of the basecoating composition being about 1.5 to about 15 meters per second, the air having a temperature ranging from about 30° C. to about 90° C.; (d) applying infrared radiation and heated air simultaneously to the basecoating composition for a period from about 30 seconds to 2 minutes, the velocity of the air at the surface of the basecoating composition being about 1.5 to 5 meters per second, the air having temperature of from about 30° C. to about 60° C., such that a sufficiently dried basecoat is formed upon the surface of the substrate; and (e) applying a topcoating composition over the basecoat.

2. The process according to claim 1, wherein the substrate is metal selected from the group consisting of iron, steel, aluminum, zinc, magnesium, alloys and combinations thereof.

3. The process according to claim 2, wherein the metal substrate is an automotive body component.

4. The process according to claim 1, wherein the period ranges from about 30 seconds to about 2 minutes in step (b).

5. The process according to claim 1, wherein the infrared radiation applied in step (d) is emitted at a wavelength in the near- to intermediate-infrared region ranging from about 0.7 to about 20 micrometers.

6. The process according to claim 5, wherein the infrared radiation applied in step (d) is emitted at a wavelength in the near-infrared region ranging from about 0.7 to about 4 micrometers.

7. The process according to claim 1, wherein the period ranges from about 30 seconds to about 45 seconds in step (c).

8. The process according to claim 7, wherein the period ranges from about 30 seconds to about 45 seconds in step (d).

9. The process according to claim 1, wherein the topcoat is applied over the basecoat wet on wet.

10. The process according to claim 1, further comprising an additional step of simultaneously curing the basecoating composition and the topcoating composition after application of the topcoating composition.

11. The process according to claim 1, wherein the substrate is a polymeric substrate and wherein the peak temperature of the substrate during the process does not exceed the heat distortion temperature of the polymeric material.

12. The process according to claim 1 wherein the radiation source is microwave energy.
